(19) United States
(12) Patent Application Publication
(10) Pub. No.: US 2013/0018735 A1
(43) Pub. Date: Jan. 17, 2013

(54) System and Method for interaction specific advertising media distribution

(71) Applicants: John Lowell Walker, Seffner, FL (US); Michael J. Dresslar, Omaha, NE (US); Charles David Mattox, Clearwater, FL (US)

(72) Inventors: John Lowell Walker, Seffner, FL (US); Michael J. Dresslar, Omaha, NE (US); Charles David Mattox, Clearwater, FL (US)

(21) Appl. No.: 13/550,592

(22) Filed: Jul. 16, 2012

Related U.S. Application Data
(60) Provisional application No. 61/508,284, filed on Jul. 15, 2011.

(51) Int. Cl. G06Q 30/02

(52) U.S. Cl. 705/14.73

(57) ABSTRACT

A system and a method are used to display and distribute interaction specific advertisement media. The system comprises a server, a plurality of interactive display stations, and a plurality of primary network connections. Each interactive display station is communicatively coupled to the server by a primary network connection. Each interactive display station comprises a general interest display, a plurality of peripheral ad panels, a process control module, at least one camera, and a plurality of network connections. The peripheral ad panels are positioned around the general interest display, and the process control module manages the software that is used to display and distribute the advertisements. The specific advertisement playing on the display stations depend on whether or not a person is in front of the display station and the demographic characteristics of that person.

The current application claims a priority to the U.S. Provisional Patent application Ser. No. 61/508,284 filed on Jul. 15, 2011. The current application is filed in the U.S. on Jul. 16, 2012 while Jul. 15, 2012 was on a weekend.

### FIELD OF THE INVENTION

The present invention relates generally to a system and method for distributing advertising content. More particularly, to a system and method of distributing interaction specific ad media to a system of display station networks capable of interpreting locally generated dynamic data for displaying a particular ad media.

### BACKGROUND OF THE INVENTION

General interest displays such as televisions, flat panels, monitors and other such image and video presentation devices, serve a plurality of functions in public settings. These displays serve function that include, but are not limited to, viewing a sports game at a bar, viewing closed circuit security camera feeds in a local stores, a distraction while in a waiting room, the score screen at a bowling alley, and various other public content viewing functions. These displays provide engaging visual content of a photographic or video medium viewable to individuals within the immediate vicinity. While these displays serve various functions as standalone devices, these displays provide a great opportunity for advertisers.

In most situations general interests displays are limited to presenting advertising content in the form of scheduled or static advertisements. These advertisements are generally scheduled commercials that are presented within the content that is being displayed. Generally, these advertisements are disruptive to the viewing of the content. In an addition commercial advertisements are greatly generalized and are unable to take into account the specific individual viewing the general interest display. While these drawback are common with television sets in waiting rooms and bars, there is little that can be done to change what is advertised on the general interest display, due to these television receiving a broadcasted signal. In display systems utilized to display scores or non-media related content such as security camera display screens, the current method used to provide advertisement s generally relates to the use of banner type ads that take up a portion of the display screen. These banner type ads suffer from many of the same disadvantages with broadcast commercial advertisements. These banner ads are typically static or have a set schedule of display. While this is a simple solution for providing a more targeted advertisement delivery system due to the circumstance relating to the individual viewing the display, these ads do not have an active method for providing user specific advertisements.

While advertisements distribution on general interest displays are well known in the art, There are newer advertisement systems that only provide advertisement content through networked advertisement display system. These advertisement system are newer billboard system that can use interactive displays that can be touch screen or just modified flat panel televisions. The touch screen system provide more specific content but have the disadvantage of only functioning as advertisement panel. The modified flat panel system, on the other hand can serve other functions but many still rely on a scheduled system for displaying advertisements. These ad systems update frequently and provide manufactures with frequent marketing statistics based consumer interactions. Typically, these system utilize a network connection to communicate with servers that provide advertisement content distribution. While both of these system provide an enhanced advertisement content experience for consumers, they both carry the disadvantage of a single function system that only servers the purpose of delivery advertisement.

Therefore, it is the object of the present invention to provide a system capable of delivering advertisement content that is targeted to an individual viewing general interest content, in a manner that does not impact viewing of the general interest content. The present invention can accomplish this through the use of a peripheral ad panels that are localized on the periphery of the general interest display. The system utilizes a camera system that can recognize visual identifier used to categorize an individual and then combine the information with the content being viewed to determine a specific piece of advertisement media to be displayed on a peripheral panel. The system additionally uses a network connection to receive updated advertisement content and to also provide scheduled advertisement statistics.

### BRIEF DESCRIPTION OF THE DRAWINGS

FIG. 1 is a block diagram illustrating the system interactions of the preferred embodiment of the present invention.

FIG. 2 is a block diagram depicting the components that comprise each of the plurality of display station networks as per the preferred embodiment of the present invention.

FIG. 3 is a block diagram depicting the interactions between the server and the process control module, and the process control module with the plurality of peripheral ad panels as per the preferred embodiment of the present invention.

FIG. 4 is a flow chart diagram depicting the general process utilized by the method to display an advertisement as per the preferred embodiment of the present invention.

FIG. 5 is a block diagram depicting the components and sub components of the plurality of interaction specific advertisements as per the preferred embodiment of the present invention.

FIG. 6 is a block diagram depicting the components of the human-specific parameters as per the preferred embodiment of the present invention.

FIG. 7 is a flow chart diagram depicting the process involved for selecting an advertisement when a human has been detected, as per the preferred embodiment of the present invention.

FIG. 8 is a perspective view that describes the positioning of the at least one camera and the general interest display relative to the station viewing area as per the preferred embodiment of the present invention.

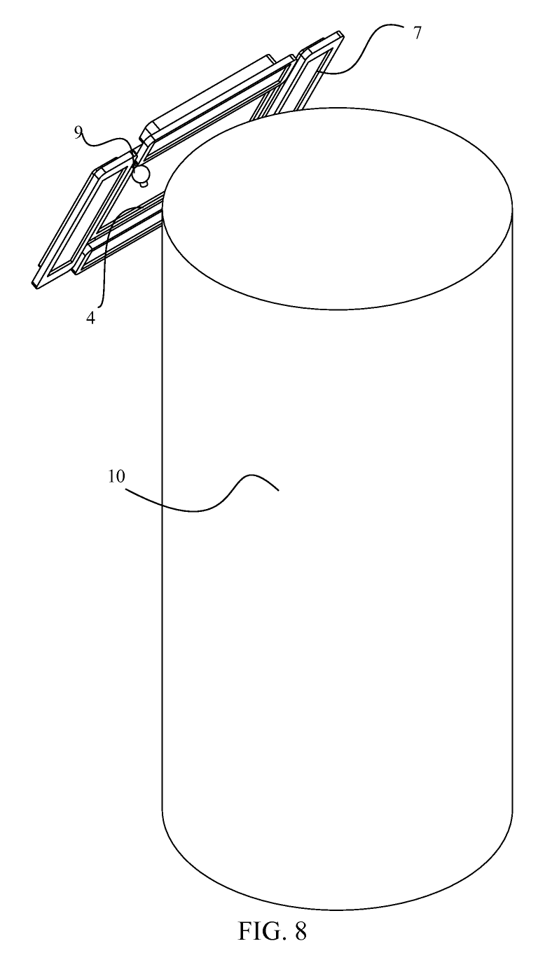

### DETAIL DESCRIPTIONS OF THE INVENTION

All illustrations of the drawings are for the purpose of describing selected versions of the present invention and are not intended to limit the scope of the present invention.

The present invention is a system and method for distributing a plurality of interaction specific advertisements to a networked system of display station networks 3 capable of interpreting locally generated dynamic data for displaying said interaction specific advertisements. The present invention comprises a networked system and a method that determines the local distribution of ad media on each. The system portion of the present invention comprises a server 1, a plurality of primary network connections 2, and a plurality of display station networks 3. The system operate as a Wide Area Network (WAN) where the server 1 remotely handles the distribution of ad media to the plurality of display station networks 3, as well as, the retrieval of interaction data relating to the displaying of ad media on a display station network 3. Each of the plurality of display station networks 3 comprise a plurality of secondary network connections 6, a general interest panel 4, a plurality of peripheral ad panels 7, a process control module 8, and at least one camera 9. The general interest panel 4 comprises a media player 5. Each of the plurality of display station networks 3 manage the interpretation of locally acquired dynamic data that is received from the general interest panel 4 and the at least one camera 9 in the form of general interest content and visual data, respectively.

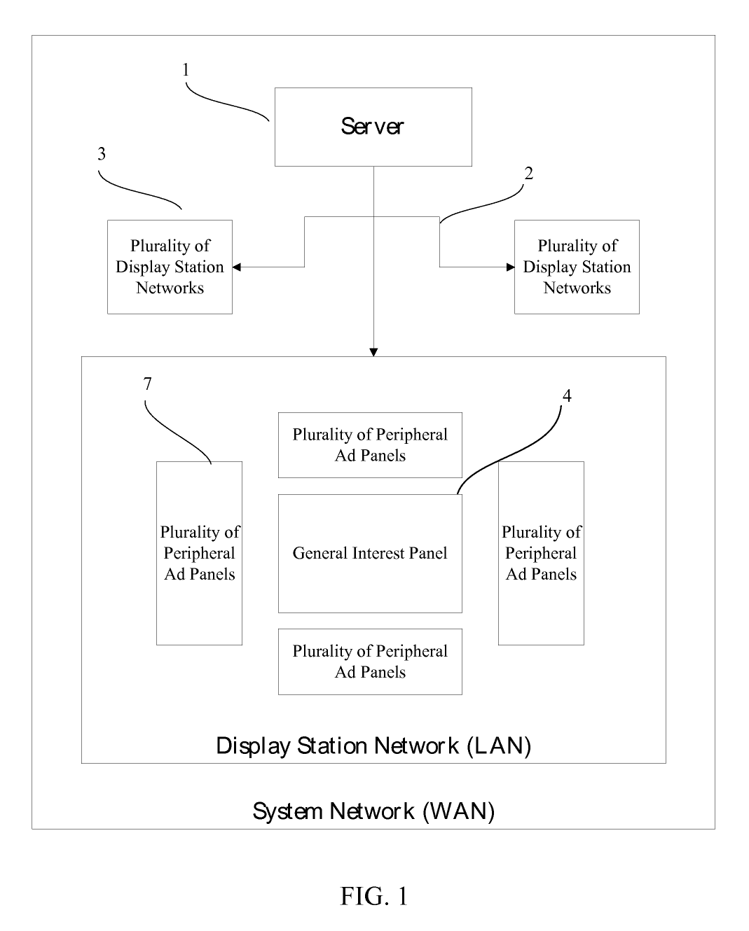

Referencing FIG. 1, the system of the present invention functions as a WAN, wherein the server 1 and the plurality of display station networks 3 are communicatively coupled through the plurality of primary network connections 2. The server 1 of the present invention functions as the remotely localized entity that hosts a computerized process responsible for the distribution of the plurality of interaction specific advertisements to the plurality of display station networks 3. The plurality of interaction specific advertisements is provided to the server 1 in digital format and is stored locally with the server 1. The server 1 distributes the plurality of interaction specific advertisements to the plurality of display station networks 3. The server 1 retrieves interaction logs from each of the plurality of display station networks 3, detailing the individual interactions resulting in the displaying of an optimal interaction specific advertisement. The server 1 accomplishes these interactions with the plurality of display station networks 3 through the primary network connections 2.

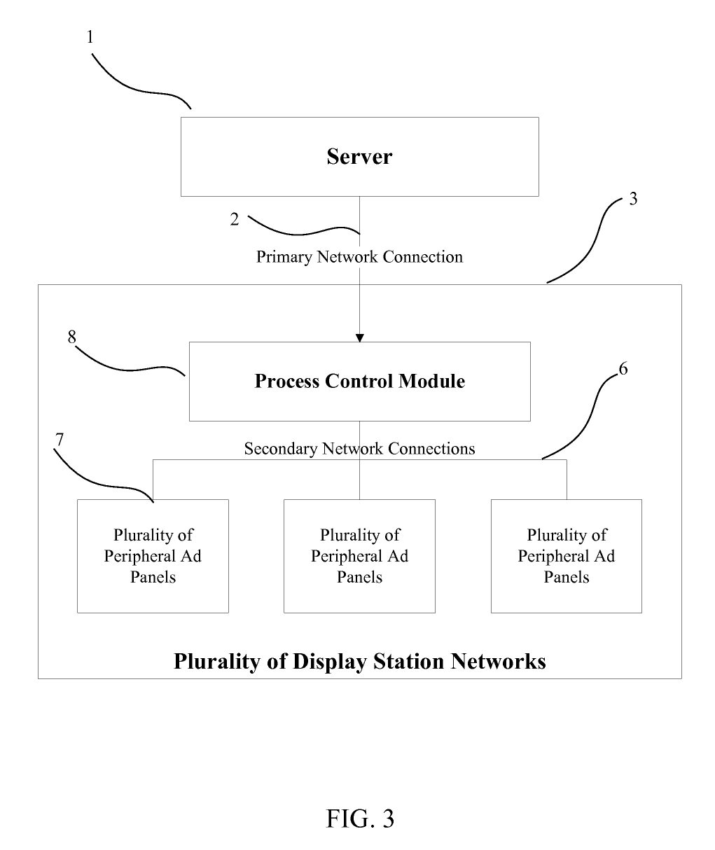

Referencing FIG. 3, the primary network connections 2 provide the present invention with a communication channel between the plurality of display station networks 3 and the server 1. The primary network connections 2 allow the transmittal of digital information between the server 1 and the plurality of display station networks 3. Resultantly, the primary network connections 2 function as the communication channel through which the interaction specific advertisements and the interaction logs are transmitted between the server 1 and the plurality of display station networks 3. The primary network connections 2 utilizes personal or commercial telecommunication channels as well as combinations thereof to establish communication channels that can cover a broad area. Resultantly, the primary network connections 2 establish the interactions between the plurality of display stations and the server 1 as a WAN.

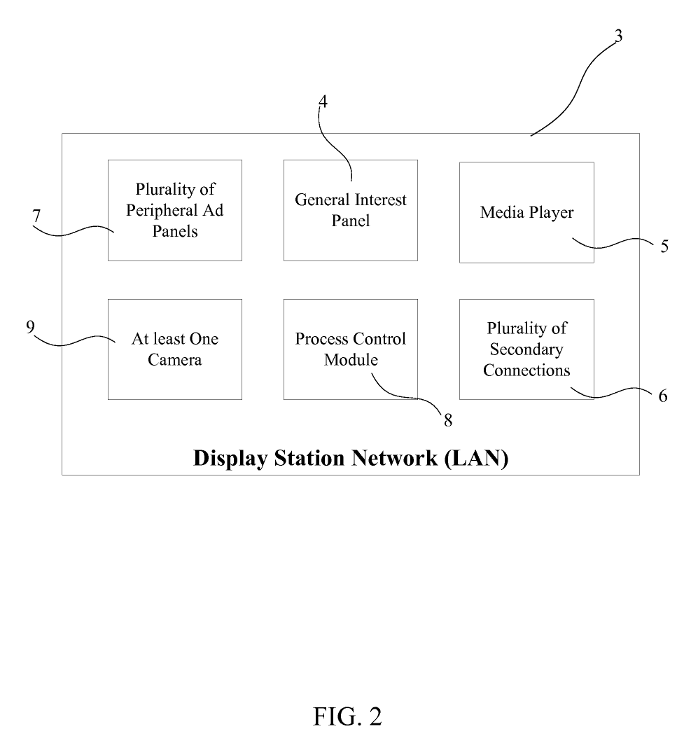

Referencing FIG. 1 and FIG. 2, the plurality of display station networks 3 of the present invention function as the network clients that receive ad media from the server 1 by way of the primary network connection 2. Each of the plurality of display station networks 3 function as a local area networks (LAN), wherein the process control module 8, general interest panel 4, the plurality of peripheral ad panels 7, and the at least one camera 9, are communicatively connected by way of the plurality of secondary network connections 6. In each of the plurality of display station networks 3, the process control module 8 serves as the local host, while the general interest panel 4, the plurality of peripheral ad panels 7 and the at least one camera 9 function as the clients. Each of the plurality of display station networks 3 receive dynamic data from local interaction. Local interactions are interpreted by a display station network 3 and are used to determine the displaying of a particular advertisement.

Referencing FIG. 2, each of the plurality of display station networks 3 utilize a process control module 8 to process dynamic data generated from local interactions, to receive and store a plurality of advertisements, to distribute said advertisements based on processed dynamic data, and to record interaction details into an interaction log for retrieval by the server 1. The server 1 contacts the process control module 8 by way of a primary network connection 2. The server 1 sends the plurality of advertisements to the process control module 8. The process control module 8 stores the plurality of advertisements. The process control module 8 functions as the host for the display station network 3. The process control module 8 is communicatively connected to the plurality of peripheral ad panels 7, to the general interest panel 4, and to the at least one camera 9 by way of a plurality of secondary network connections 6. The process control module 8 receives dynamic data from the general interest display and the at least one camera 9. The general interest panel 4 provides the process control module 8 with content description data. The at least one camera 9 provides the process control module 8 with visual data. The process control module 8 processes the dynamic data and determines the distribution of an optimal interaction specific advertisement to display to a peripheral ad panel of the plurality of peripheral ad panels 7. The process control module 8 stores the conditions that resulted in the display of an advertising media content as an interaction detail that is stored in an interaction log.

Referencing FIG. 2 each of the plurality of display station networks 3 utilizes a general interest panel 4 to display engaging general interest content. The general interest panel 4 is positioned in a manner that provides facilitated viewing by humans found in the station viewing area 10. The general interest panel 4 comprises a media player 5. The media player 5 receives general interest content as physical media or non physical media provided in a digital format. The media player 5 processes the received media into general interest content displayable on the general interest panel 4. The media player 5 extracts dynamic data from general interest content in the form of content descriptions. The media player 5 is communicatively coupled with the process control module 8 by way of a secondary network connection 6. The media player 5 transmits extracted content descriptions to the process control module 8. The media player 5 in the present invention constitutes a digital device that is capable of distributing general interest content to the general interest display. The media player 5 as described in the preferred embodiment can consist of device that include, but are not limited to, a digital video disc (DVD) player, a Blu-ray player, a system for streaming online content on television, digital video recorder (DVR) set top box, console gaming system, satellite set top box, as well as any combination thereof.

Referencing FIG. 2, each of the plurality of display station networks 3 utilizes a plurality of peripheral ad panels 7 to display visual content of a photographic or video medium depicting an advertising material for goods or services. The plurality of peripheral ad panels 7 are communicably connected to the process control module 8 by way of secondary network connections 6. The plurality of peripheral ad panels 7 each receive an advertisement from the process control module 8. The plurality of peripheral ad panels 7 is positioned around the general interest panel 4. The plurality of peripheral ad panels 7 is positioned in a manner that provides facilitated viewing of displayed advertisements by a human found in the station viewing area 10.

Referencing FIG. 2, each of the plurality of display station networks 3 utilize at least one camera 9 to collect visual data of the station viewing area 10. The at least one camera 9 is positioned towards the station viewing area 10. The at least one camera 9 collect dynamic data in the form of visual data. The at least one camera 9 is communicably connected to the process control module 8 by way of secondary network connections 6. The at least one camera 9 provides the process control module 8 with visual data. Visual data is processed to determine the presence of an human engaged viewing the general interest panel 4 or a peripheral ad panel in the station viewing area 10. Visual data is further processed by the process control module 8 to determine the presence of recognizable features, eye focus direction, and dwell time of human engaged in viewing the general interest panel 4 or peripheral ad panel in the station viewing area 10.

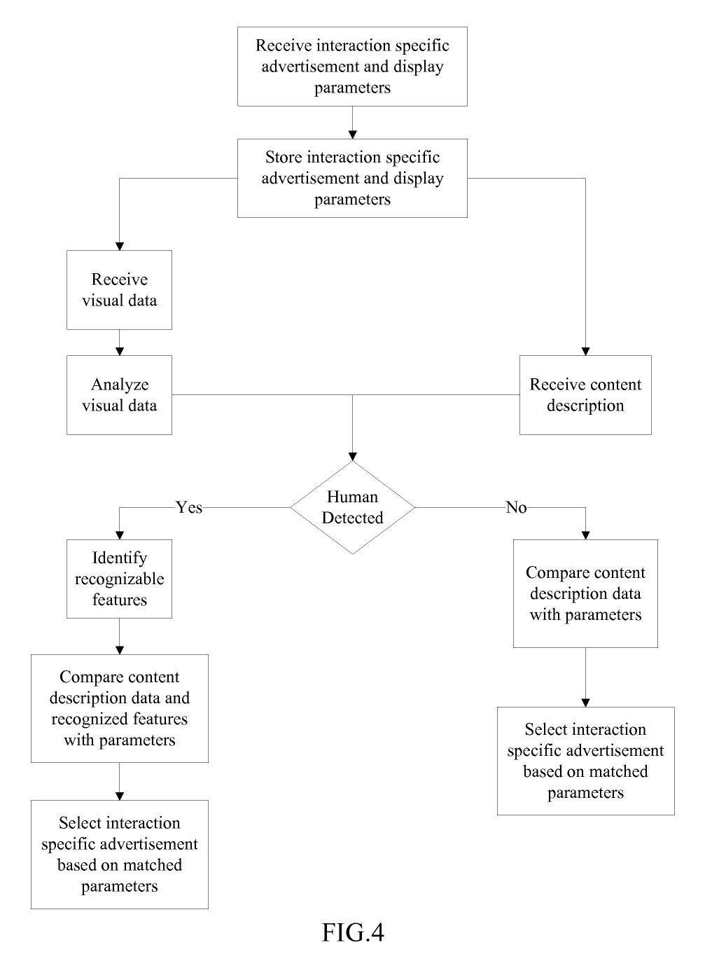

Referencing FIG. 2 and FIG. 4, each of the plurality of display station networks 3 utilizes a plurality of secondary network connections 6. The plurality of secondary network connections 6 provides the process control module 8 with a communication channel that allows the transmittal of advertisements to the plurality of peripheral ad panels 7. The plurality of secondary network connections 6 provide the process control module 8 with a communication channel that allows the reception of dynamic data from the general interest panel 4 and the at least one camera 9 in the way of content descriptions and visual data, respectively. The plurality of secondary network connections 6 utilizes local connections in the form of physical communication channels or virtual communication channels. Resultantly, the interactions between the plurality of secondary network connections 6 with the process control module 8, the general interest panel 4, the plurality of peripheral ad panels 7, and the at least one camera 9 are classified as a local area network, or a virtual local area network ,respectively. Secondary network connections 6 provide higher data transfer rates.

Referencing FIG. 4, in the present invention, the plurality of display station networks 3 receive interaction specific advertisements from the server 1 to distribute among the plurality of peripheral ad panels 7 based on local interactions. The present invention accomplishes this through the implementation of a method that processes local interactions and then governs the distribution of the advertisement media, accordingly. The method comprises several steps. Initially, the display station network 3 receives a plurality of interaction specific advertisements from server by way of the primary network connection 2, wherein each of the interaction specific advertisements comprise the human-present parameters, that correspond for when a human is detected, the human-absent parameters, that corresponds for when a person is not detected, and the advertising media content. The process control module stores the plurality of interaction specific advertisements within a database. During this instance, the process control module continuously receives visual data from the at least one camera 9. The process control module continuously receives content description data from the media player 5. The process control module processes the visual data in order to detect the presence of a human within the station viewing area 10. Due to the dynamic nature of the content description data, the process control module continuously executes a targeted advertising process for selecting optimal advertisement media content from the plurality of interaction specific advertisements. If a human is not detected in the station viewing area 10, then the display station executes an idle advertisement process to select an interaction specific advertisement from the plurality of interaction specific advertisements based on the human-absent parameters. The display station network 3 then distributes the advertisement media content to one of the peripheral ad panels 7. If a person is detected in the station viewing area 10, then the display station executes a targeted advertising process to further process the visual data. The display station then executes a process to select an interaction specific advertisement from the plurality of interaction specific advertisements based on the human-present parameters. Simultaneously, the display station executes a process that tracks eye movement to determine where the person is looking in order to display the advertisement a peripheral ad panel. After each instance that an interaction specific advertisement is selected and displayed, the display station network 3 records the interaction details for retrieval by the server 1.

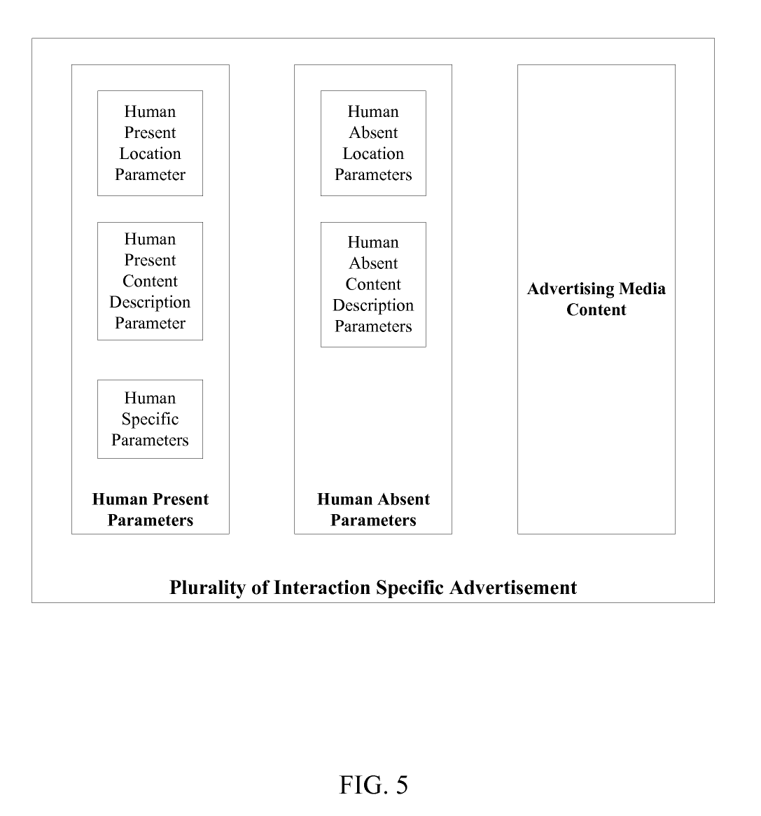

Referencing FIG. 4 and FIG. 5, in the present invention the server 1 and the display station network 3 have an established communication channel provided by a primary network connection 2. The display station network 3 comprises a general interest panel 4, an at least on camera, a station viewing area 10, current location data, a media player 5, and a process control module 8. The station viewing area 10 comprises an area where a human is able to engage the general interest panel 4, as well as being within the field of view of the at least one camera 9. The current location data comprises an identifying value that is particular to the display station that connotes the location where the display station network 3 is being operated. The server 1 is responsible for distributing and retrieving data from the display station network 3. The plurality of interaction specific advertisements is received by the process control module 8 of the display station network 3. Each of the plurality of interaction specific advertisements comprises the human-present parameter, the human-absent parameter, and the advertising media content. The human-present parameter comprises the human-present location parameter, the human-present content description parameter, and the human-specific parameter. The human-present location parameter comprises a conditional value for displaying the advertising media content, when a human is present in the station viewing area 10, based on the location of the display station network 3. The human-present content description parameter comprises a conditional value for displaying the advertising media content, when a human is present in the station viewing area 10, based on the content description detail provided by the media player 5. The human-specific parameter comprises a set of conditional values for displaying the advertising media content dependent on recognized features that must be present in a human found in the station viewing area 10. The human-absent parameter comprises the human-absent location parameter and the human-absent content description parameter. The human-absent location parameter comprises a conditional value for displaying the advertising media content when a human is absent from the station viewing area 10, based on the location of the display station. The human-absent content description parameter comprises a conditional value for displaying the advertising media content when a human is absent from the station viewing area 10, based on the content description detail provided by the media player 5.

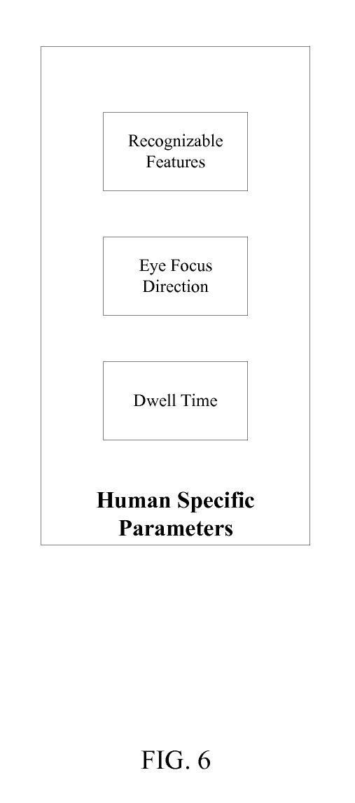

Referencing FIG. 4-7, each of the plurality of interaction specific advertisements received by the process control module 8 is stored to an interaction specific advertisement database. The interaction specific advertisement database comprises a searchable database that stores the received interaction specific advertisements for the distribution of the advertising media content based on matched human-present or human-absent parameters. In the current embodiment of the present invention, the interaction specific advertisement database provides a continuously searchable database and provides high read and write speeds for receiving and accessing interaction specific advertisements.

Referencing FIG. 4-7, the process control module 8 continuously receives dynamic data in the form of visual data and content description data. The at least one camera 9 continuously provides the process control module 8 with visual data of the station viewing area 10 by way of the secondary network connections 6. The media player 5 continuously provides the process control module 8 with content description data wherein the content description data is a computer readable description of the general interest content that is being displayed on the general interest panel 4.

Referencing FIG. 4-7, the process control module 8 continuously processes the visual data received in order to detect the presence of a human within the station viewing area 10. The process control module 8 continuously receives visual data from the at least one camera 9, the visual data is immediately analyzed by the process control module 8 to identify the presence of a human engaged with the general interest panel 4. In the present invention the process control module 8 utilizes facial recognition software that distinguishes features that are most associated with a human. It should be noted that the current software method for detecting the presence of a human can potentially be substituted with other visual data analysis software or another effective method that is well known in the art. When a human is detected the process control module 8 further analyzes the visual data to extract human-specific data. The human-specific data comprises recognized features, eye focusing location, and dwell time. The recognized features are visual identifiers defined in the process control module 8 that provide the process control module 8 the ability to further classify the human based on a single or a combination of visual identifiers. The eye focusing location is the direction of a human's eyes while the human is engaged viewing the general interest panel 4 while in the station viewing area 10. The dwell time is the length of the interval of time that the individual was engaged with the peripheral ad panel of the plurality of peripheral ad panels Tor engaged with the general interest panel 4.

Referencing FIG. 4, the process control module 8 runs an idle advertising process during the instances that a human is absent from the station viewing area 10. The idle advertising process is used to select the optimal interaction specific advertisement from the interaction specific advertisement database, based on current dynamic values being received from the media player 5 and the at least one camera 9. The process control module 8 continuously receives content description data from the media player 5. If the further processing of the visual data from the at least one camera 9 determines that a human is not detected in the station viewing area 10, the process control module 8 selects the optimal interaction specific advertisement. The process control module 8 accesses the human-absent parameters for each of the plurality of interaction specific advertisements stored in the interaction specific advertisement database. The process control module 8 compares the current location data against the human-absent location parameters for each of the plurality of interaction specific advertisements stored in the interaction specific advertisement database. The process control module 8 compares the content description data against the human-absent content description parameters for each of the plurality of interaction specific advertisements stored in the interaction specific advertisement database. The process control module 8 selects the optimal interaction specific advertisement based on matching all parameter values. The process control module 8 then retrieves the corresponding advertising media content from the interaction specific advertisement database. The process control module 8 then distributes the selected advertising media content to a peripheral ad panel for displaying.

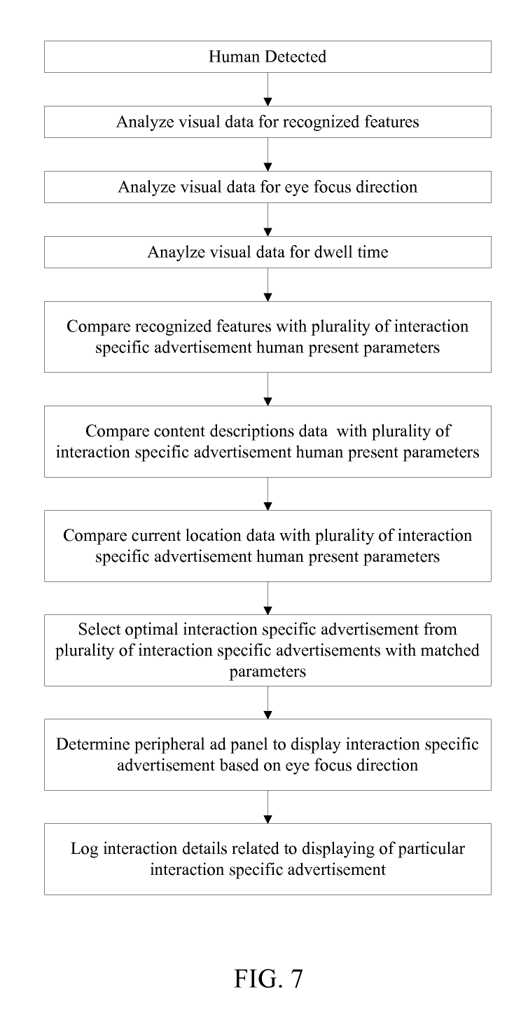

Referencing FIG. 7, if further processing of the visual data from the at least one camera 9 determines that a human is detected in the station viewing area 10. The process control module 8 executes the system targeted advertisement selection process. The process control module 8 further analyzes the visual data to obtain the human-specific data. When the process control module 8 has obtained the human-specific data, the process control module 8 accesses the human-present parameters for each of the plurality of interaction specific advertisements stored in the interaction specific advertisement database. The process control module 8 compares the current location data against the human-present location parameters for each of the plurality of interaction specific advertisements stored in the interaction specific advertisement database. The process control module 8 compares the content description data against the human-present content description parameters for each of the plurality of interaction specific advertisements stored in the interaction specific advertisement database. The process control module 8 compares the human-specific data against the human-specific parameters of each of the plurality of interaction specific advertisement s stored in the interaction specific advertisement database. The process control module 8 selects the optimal interaction specific advertisement based on matching all parameter values. The process control module 8 then retrieves the corresponding advertising media content from the interaction specific advertisement database. The process control module 8 determines the distribution of the advertising media content to a particular peripheral ad panel based on human-specific data. The process control module 8 utilizes the eye focusing direction as a determinant for the distribution of selected advertising media content. The process control module 8 determines an optimal peripheral ad panel which to display the selected advertising media content based on eye focusing direction.

Referencing FIG. 7, the process control module 8 records the details of the interactions that resulted in the displaying of an optimal interaction specific advertisement. The process control module 8 records each event where an advertising media content is displayed on a peripheral ad panel. The interaction details record the matched parameters, such as the human-absent location parameter, the human-absent content description parameter, the human-present location parameter, the human-present content description parameter, and the human-specific parameters met resulting in the displaying of an optimal interaction specific advertisement. The process control module 8 additionally stores data regarding the eye focusing direction and the dwell time for when human-present parameters are met. The interaction details are stored in an interaction log that comprises the plurality of interaction details collected for the all selections of optimal interaction specific advertisements. The process control module 8 makes the interaction log retrievable by the server 1 by way of the primary network connections 2.

Although the present invention utilizes content description data, current location data, and human-specific data to determine what specific advertisement is shown, an additional embodiment of the present invention could potentially utilizes special parameters that are not related to the preferred set of parameters. An additional embodiment could potentially utilizes parameters sets for displaying advertisements on a display station network 3 based on values that include but are not limited to, weather, news, sounds, changes in lighting, or schedules parameters.

Although the present invention utilizes advertising media content in the form of photographic or video content, an additional embodiment of the present invention can potentially utilizes interactive touch screen displays that would be able to provide additional information which could potentially be used to determine the displaying of a more specific advertisement to a human or group of humans.

Although the present invention utilizes an interaction log that is retrieved by the server 1, an additional embodiment can potentially utilizes a location based system that incorporates a quick response (QR) code with an embedded URL that designate the location of the display station network 3 where the human received the QR code. The QR code can be provided in a manner that allows the URL identifier for the particular location to be affixed by the process control module 8. This feature allows the server 1 to send out a generic QR code that can be modified by any display station network 3 to provide near instantaneous advertisement statistics when used.

In the present embodiment of the invention the display station network 3 is manufactured a standalone unit, but in an additional embodiment the invention can be a retrofit system that allows existing television, liquid crystal displays (LCD), or any device that functions as a general interest panel 4 to have the option of a peripheral ad panel, process control module 8, and at least one camera 9 to be attached or placed around the general interest display.

In an additional embodiment of the present invention the peripheral ad panels 7 can be substituted for a larger display that is sectioned in manner that provides the several panel that are perimetrically positioned around a central panel that serves as the general interest panel 4. In an additional embodiment of the present invention he general interest panel 4 can comprise several general interest panels 4 that each displays a different content of general interest.

In another additional embodiment of the present invention the display station network 3 can function in unison with specific media inserted into the media player 5. An example of this is a training video that can potentially utilizes the peripheral ad panels 7 to displays solutions or answers that coincide with the images that are displayed on the general interest panel 4. In addition the additional embodiment could potentially include a mode that allows peripheral ad panels 7 to be overridden in certain circumstances to serve as peripheral general interest displays.

Yet another additional embodiment of the present invention could potentially have the process control module 8 managing the distribution of interaction specific advertisement content to a plurality of general interest panels 4 and peripheral ad panels 7. The process control module 8 can manage multiple display stations.

Still in another additional embodiment of the present invention actions performed by the process control module 8 are carried out remotely by the server for by components that are already present in the invention.

Although the present invention utilizes a plurality of peripheral ad panels 7 around the general interest panel 4, it should be understood that it would be an obvious difference to include at least one peripheral ad panel.

Although the present invention utilizes a standalone configuration, it should be understood that the use of peripheral ad panels 7 wirelessly positioned around a general interest display would be an obvious difference.

Although the present invention utilizes a LAN as the connection type for the system, it should be an obvious difference to have certain components based in no local locations, such as the process control module 8.

Although the invention has been explained in relation to its preferred embodiment, it is to be understood that many other possible modifications and variations can be made without departing from the spirit and scope of the invention as hereinafter claimed.

What is claimed is:

1. An interaction specific advertisements distribution system comprises, a server;
a plurality of display station networks;
a plurality of primary network connections;
the plurality of display station networks comprise a general interest panel, a plurality of peripheral ad panels, a process control module, at least one camera, and a plurality of secondary network connections; and
the general interest panel comprises a media player.

2. The interaction specific advertisements distribution system as claimed in claim 1, wherein the process control module is a local process distribution mechanism.

3. The interaction specific advertisements distribution system as claimed in claim 1, wherein the process control module is a remote process distribution mechanism.

4. The interaction specific advertisements distribution system as claimed in claim 1 comprises,
the server being communicatively coupled to the process control module of each of the plurality of display station networks by the plurality of primary network connections; and
the process control module being communicatively coupled to the general interest panel, to the at least one camera, and to each of the plurality of peripheral ad panels by the plurality of secondary network connections.

5. The interaction specific advertisements distribution system as claimed in claim 1 comprises,
the at least one camera being positioned towards a station viewing area, wherein the station viewing area is an area that a person can see visual content being shown by a display station.

6. The interaction specific advertisements distribution system as claimed in claim 1 comprises,
each of the plurality of peripheral ad panels being perimetrically positioned around the general interest panel.

7. A method of distributing interaction specific advertisements to a display station by executing computer-executable instructions stored on a non-transitory computer-readable medium, the method comprises the steps of:
providing a server and an display station , wherein the display station includes a general interest panel, a plurality of peripheral ad panels, an at least one camera, a media player, a station viewing area, and current location data;
receiving a plurality of interaction specific advertisements from the server, wherein each of the plurality of interaction specific advertisements includes human-present parameters, human-absent parameters, and advertising media content;
storing the plurality of interaction specific advertisements within a database;
continuously receiving visual data from the at least one camera;
continuously receiving content description data from the media player;
processing visual data in order to detect a human within the station viewing area;
executing an idle advertising process in order to select a advertising media content from the plurality of interaction specific advertisements,
if a human is not detected within the station viewing area;
executing a targeted advertising process in order to select the advertising media content from the plurality of interaction specific advertisements,
when the human is detected within the station viewing area;
displaying the advertisement media content of the optimal interaction specific advertisement by sending advertisement media content of the optimal interaction specific advertisement to an optimal peripheral ad panel of the plurality of peripheral ad panels; and
recording the interaction details of displaying advertising media content of the an optimal interaction specific advertisement.

8. The method of distributing interaction specific advertisements to a display station by executing computer-executable instructions stored on a non-transitory computer-readable medium, the method as claimed in claim 7 comprises the steps of:
accessing the human-absent parameters for each of the plurality of interaction specific advertisement from the database, wherein the human-absent parameters include a human-absent location parameter and a human-absent content description parameter;
comparing the human-absent location parameter for each of the plurality of interaction specific advertisements to the current location data;
comparing the human-absent content description parameter for each of the plurality of interaction specific advertisements to the content description data; and
matching the human-absent location parameter and the human-absent content description parameter of the optimal interaction specific advertisement to the current location data and the content description data.

9. The method of distributing interaction specific advertisements to a display station by executing computer-executable instructions stored on a non-transitory computer-readable medium, the method as claimed in claim 7 comprises the steps of:
analyzing the visual data in order to extract human-specific data from the visual data, wherein the human-specific data includes recognizable features, eye focusing location, and dwell time,
when the human is detected within the station viewing area;
accessing the human-present parameters for each of the plurality of advertisements from the database, wherein the human-present parameters include a human-present location parameter, a human-present content description parameter, and a human-present human-specific data;
comparing the human-present location parameter for each of the plurality of interaction specific advertisement to the current location data;
comparing the human-present content description parameter for each of the plurality of the interaction specific advertisement to the content description data;
comparing the human-present human-specific parameter for each of the plurality of the interaction specific advertisement to the human-specific data; and
matching the human-present location parameter, the human-present content description parameter, and the human-present human-specific parameter of the optimal advertisement to the current location data, the content description data, and the human-specific data.

10. The method of distributing interaction specific advertisements to a display station by executing computer-executable instructions stored on a non-transitory computer-readable medium, the method as claimed in claim 7 comprises the steps of:
recording the human-absent location parameter and the human-absent content description parameter of the optimal interaction specific advertisement,
if the human is not detected within the station viewing station; and
recording the human-present location parameter, the human-present content description parameter, and the human-present human-specific parameter of the optimal interaction specific advertisement,
when the human is detected within the station viewing station.
